(19) United States
(12) Patent Application Publication
(10) Pub. No.: US 2009/0127117 A1
(43) Pub. Date: May 21, 2009

(54) HIGH PRESSURE-RESISTANT TYPE ELECTRICAL DEIONIZATION APPARATUS, HIGH PRESSURE-RESISTANT TYPE ELECTRICAL DEIONIZATION SYSTEM AND METHOD OF PRODUCING ULTRAPURE WATER USING HIGH PRESSURE-RESISTANT TYPE DEIONIZATION SYSTEM

(75) Inventors: Shinji MIURA, Tokyo (JP); Syuichi Ueno, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: EBARA CORPORATION, Ohta-ku (JP)

(21) Appl. No.: 12/248,488

(22) Filed: Oct. 9, 2008

(30) Foreign Application Priority Data
Oct. 11, 2007 (JP) 2007-265103

(51) Int. Cl. C02F 1/469; B01J 47/14

(52) U.S. Cl. 204/519; 204/632; 204/628

(57) ABSTRACT

The present invention provides an electrical deionization apparatus suitable for an ultra pure water production system allowing high pressure raw water from an atomic power plant to be reused as the ultra water. The electric deionization stack 10 comprises a plurality of compartments defined by a compartment frame 11 and an ion exchange membrane 12. The compartments at the opposite ends construct an anode compartment 13 and a cathode compartment 14. The compartments, which are located between the anode compartment 13 and the cathode compartment 14, construct at least one concentrating compartment 15 and at least one deionizing compartment 16. Each compartment frame 11a constructing the concentrating compartment 15 has a concentrated water outlet 17. Each compartment frame 11b constructing the deionizing compartment 16 has a treated water outlet 18. In the pressure vessel 20, a concentrated water chamber 24 and a treated water chamber 25 are partitioned by a partition plate 23. Into the concentrated water chamber 24, the concentrated water flows from the concentrated water outlet 17 of the electric deionization stack 10. Into the treated water chamber 25, the treated water flows from the treated water outlet 18.

### BACKGROUND OF THE INVENTION

The present invention relates to an electrical deionization system suitable for producing ultra pure water, in particular, a high pressure-resistant type electrical deionization system for treatment of service water and wastewater in a field where instruments such as nuclear facilities are required to meet strict standards defined by laws and regulations.

Typically, in treatment facilities for service water and wastewater in facilities using radioactive materials, such as an atomic power plant, an ion exchange apparatus using particulate ion exchange resin has been used to remove ionic components as impurities. Such an apparatus removes impurity ions by flowing raw water through an ion exchange column filled with ion exchange resins.

However, ion exchange resins have a limited exchange capacity. It is necessary to replace broken through ion exchange resins with new ion exchange resins or to regenerate used ion exchange resins with a regeneration chemical solution such as an alkali solution and an acidic solution prior to breakthrough of the ion exchange resins. It is necessary to further treat and to finally dispose of used ion exchange resins and wastewater used for regeneration of the used ion exchange resins in a radioactive waste treatment plant since the raw water to be treated in the nuclear facilities includes radioactive materials. In addition, a volume of expensive ion exchange resins are needed to periodically replace the used ion exchange resins.

As mentioned above, the radioactive liquid waste disposal generated from the nuclear facilities must be cleaned up within an in-house treatment plant to lower the concentration of the radioactive materials and other impurities to a level below the standard value defined by a regulation. The radioactive liquid waste disposal having low level of radioactive materials is then recovered and reused within the in-house plants or released to an ocean. However, impurities including radioactive materials separated from the liquid are concentrated and finally solidified with cement in a drum can, and the solidified waste is stored in the facilities and then delivered to a final treatment plant. This treatment of the radioactive waste is very expensive. Thus, volume reduction of radioactive waste is needed. In particular, the used ion exchange resins are difficult to burn and to reduce in volume by incineration. The used ion exchange resins are usually retained in storage facilities, causing a problem of storage capacity of the facilities.

To remove the impurity ions to produce ultra pure water, an electrical deionization apparatus where regeneration of ion exchange resins with chemicals and frequent replacement of ion exchange resins are not necessary, is used in place of the prior ion exchange resins. The electrical deionization apparatus is a device to obtain ultra pure water wherein one or more desalt compartment and concentration compartment defined by one or more ion exchange membranes are located between an anode compartment and a cathode compartment, which are at opposite ends, application of voltage between the anode and the cathode moves the impurity ions in the raw water toward the anode and the cathode through the ion exchange membrane depending on their polar characters, the impurity ions are concentrated in the concentration compartment to obtain a concentrated liquid and the impurity ions are removed in the desalt compartment to obtain ultra pure water. The electrical deionization apparatus needs only electrical power to remove the impurity ions from the raw water since the ions are moved to the anode compartment or the cathode compartment depending on the electrical polar character. The electrical deionization apparatus does not need regeneration of the used ion exchange resins and periodical replacement of the ion exchange resins. Thus, the electrical deionization apparatus can reduce the radioactive waste disposal, which needs secondary treatment.

However, the prior electrical deionization apparatus does not have high-pressure resistance, which is necessary to use the apparatus in the nuclear facilities dealing with radioactive material. The prior electrical deionization apparatus has a filter-pressed stacked form wherein a plastic frame including an anode exchange non-woven fabric and an anode exchange membrane are laminated and compressed. The pressure resistance of such filter-pressed stacked form of the plastic frames ranges generally from 0.3 MPa to 0.5 MPa. When the pressure above the range is applied to the stacked form of plastics frames, a leakage from sealing portions may occurred. For example, in a boiling-water reactor (BWR) type atomic power plant, steam generated in an atomic reactor is used to drive a turbine to generate power and then the steam is cooled in a main condenser at a negative pressure to a steam condensate. After that, the pressure of the steam condensate is increased to about 1.5 MPa using a low pressure condensate pump, cleaned up by removing impurities by use of a steam condensate cleaner, fed to the atomic reactor as a coolant at a high pressure of about 6.5 MPa via a high pressure condensate pump, a feed-water heater and a feed-water pump. The atomic reactor is a use point and a hot well of the main condenser is a source of raw water.

In addition, it was difficult to directly treat the raw water having middle-high pressure by use of the prior electrical deionization apparatus since it is necessary that the differential pressure between the pressure within the deionization compartment and the pressure within the concentrating compartment is below 0.05 MPa to prevent inner leakage of the prior electrical deionization apparatus. Accordingly, as shown in FIG. 1, raw water having the high pressure is first introduced into a reservoir tank to release the pressure and then introduced into the electrical deionization apparatus by use of a low-pressure pump. Further, when the treated water from the electrical deionization apparatus is reused as service water within the high-pressure plants, the treated water is introduced into the reservoir tank where the pressure is applied to the treated water by use of a high-pressure pump and then is delivered to the high-pressure plants. Thus, when the prior electrical deionization apparatus is incorporated into the ultra pure water producing system in the high-pressure plants, the system is larger, causing problems that the investment in facilities becomes huge and the operation of the system is complex. In fact, in particular, it is impossible to replace the existing ion exchange resin column in the atomic power plant with the electrical deionization apparatus due to space limitations for installation of the apparatus. Further, when the reservoir tank is used to release the pressure of the wastewater from the high-pressure plants, oxygen and carbon dioxide from the air are dissolved into the raw water to increase the level of the impurities causing the increase of load against the treatment capacity.

In short, deterioration of water quality is caused in the case that the raw water from the high-pressure water utilization plants is treated by the prior electrical deionization apparatus, if the service water and the waste water are introduced into the prior electrical deionization apparatus without their pressure being controlled, the leakage from the deionization compartment is caused as well as the inner leakage being caused when the pressure within the concentrating compartment is not adequately controlled to meet the pressure within the desalt compartment.

### SUMMARY OF THE INVENTION

An object of the present invention, therefore, is to provide an electrical deionization apparatus suitable for an ultra pure water production system capable of regeneration and reuse of high pressure raw water from, for example, an atomic power plant. In particular, an object of the present invention is to provide a high pressure-resistant type electrical deionization system wherein a high pressure raw water from a hot well of a main condenser is directly introduced into an electrical deionization apparatus to produce ultra pure water and deliver the produced ultra pure water to a use point such as an atomic reactor, and a method of producing ultra pure water using such a system.

The present inventors have found that an electric deionization stack is housed in a pressure vessel such that the pressure vessel becomes an outer wall of the electrical deionization apparatus, the isobaric fluid exists inside and outside the electric deionization stack within the pressure vessel, thereby to eliminate the differential pressure applied on the ion exchange membranes and the ion exchange non woven fabrics, if present, constructing the electric deionization stack.

The present invention provides a high pressure-resistant type electrical deionization apparatus comprising an electric deionization stack housed in a pressure vessel wherein the electric deionization stack comprises a plurality of compartments partitioned by a compartment frame and an ion exchange membrane; an anode compartment and a cathode compartment located respectively at opposite ends of the stack; at least one concentrating compartment and at least one deionizing compartment each formed between the anode compartment and the cathode compartment wherein each compartment frame forming the concentrating compartment comprises an inlet and an outlet for concentrated water (a concentrated water inlet and a concentrated water outlet) and each compartment frame forming the deionizing compartment comprises an inlet and an outlet for treated water (a treated water inlet and a treated water outlet); wherein the pressure vessel comprises a concentrated water chamber and a treated water chamber partitioned by a partition plate wherein the concentrated water from each concentrated water outlet of the electric deionization stack flows into the concentrated water chamber and the treated water from each treated water outlet of the electric deionization stack flows into the treated water chamber.

According to the present invention, a high pressure-resistant type electrical deionization system is provided. The system of the present invention comprises: a line for introducing concentrated water (concentrated water introduction line) and a line for discharging concentrated water (concentrated water discharge line) connected to the electrical deionization apparatus; a concentrated water tank connected to the concentrated water introduction line and the concentrated water discharge line; a pressure sensor for monitoring the pressure at the concentrated water outlet (a concentrated water outlet pressure sensor) and a valve for controlling the pressure at the concentrated water outlet (a concentrated water outlet valve) attached to the concentrated water discharge line; a controller for controlling the concentrated water outlet valve (a concentrated water outlet valve controller); a raw water introduction line and a line for discharging the treated water (a treated water discharge line) connected to the electrical deionization apparatus; a valve for controlling the flow rate of the raw water (a raw water flow rate control valve) attached to the raw water introduction line; a pressure sensor for monitoring the pressure at the treated water outlet (a treated water outlet pressure sensor) attached to the treated water discharge line; wherein the treated water outlet pressure sensor, the concentrated water outlet pressure sensor and the concentrated water outlet pressure controller are electrically connected to each other, and the concentrated water outlet control valve is controlled by the concentrated water outlet pressure controller such that the differential pressure between pressure at the treated water outlet detected by the treated water outlet pressure sensor and pressure at the concentrated water outlet detected by the concentrated water outlet pressure sensor is controlled to ±0.05 MPa.

Further, the present invention provides a method for producing ultra pure water using the high pressure-resistant type electrical deionization system of the present invention. The method of the present invention comprises the steps of controlling the control valve attached to the raw water introduction line to set the flow rate of the raw water needed to the use point; introducing the raw water into the deionizing compartment of the high pressure-resistant type electric deionization stack; applying the voltage on the anode and cathode; during deionization of the raw water, detecting a pressure at the treated water outlet [A] by the treated water outlet pressure sensor and a pressure at the concentrated water outlet [B] by the concentrated water outlet pressure sensor by applying the voltage; controlling the control valve such that the differential pressure between the pressure at the treated water outlet [A] and the pressure at the concentrated water outlet [B] is within ±0.05 MPa.

According to the high pressure-resistant type electrical deionization apparatus of the present invention, the raw water from ultra pure water production process using the middle-high pressure wherein the prior electric deionization stack is hardly applied due to the pressure resistance performance, can be directly flowed through the electrical deionization apparatus of the present invention without controlling the pressure using the reservoir tank and the pumps, the treated water with the pressure maintained can be delivered to the ultra pure water production process, and thus the replacement of the prior ion exchange apparatus with the high-pressure resistant type electrical deionization apparatus is accomplished. Thus, according to the present invention, the wastewater from the regeneration of ion exchange resin and the waste materials such as the used ion exchange resin can be significantly reduced, and the cost of chemicals for regeneration and new ion exchange resin is also reduced, whereby the running cost of the entire plant can be reduced.

### BRIEF DESCRIPTION OF THE DRAWINGS

FIG. 1 is a configuration diagram of the prior ultra pure water production system;

FIG. 2 is a perspective view of one preferred embodiment of the high pressure-resistant type electrical deionization apparatus of the present invention;

FIG. 3 is a sectional view along with line II-II of FIG. 2;

FIG. 4 is a sectional view along with line II-III of FIG. 2;

FIG. 5 is a sectional view along with line IV-IV of FIG. 2;

FIG. 6 is a schematic view of one embodiment of the high pressure-resistant type electrical deionization system with the high pressure-resistant type electrical deionization apparatus of the present invention;

FIG. 7 is a schematic view of another embodiment of the high pressure-resistant type electrical deionization apparatus of the present invention.

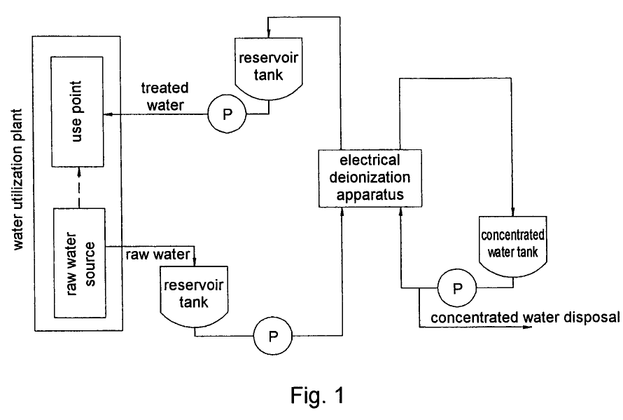

### DETAILED DESCRIPTION OF THE PREFERRED EMBODIMENTS

The present invention will be explained by referring the drawings.

In the drawings, 1 indicates a high pressure-resistant type electrical deionization apparatus, 10 indicates an electric deionization stack, 11 indicates a compartment frame, 12 indicates an ion exchange membrane, 13 indicates an anode compartment, 14 indicates a cathode compartment, 15 indicates a concentrating compartment, 16 indicates a deionizing compartment, 17 indicates a concentrated water outlet, 18 indicates a treated water outlet, 19 indicates a liquid feeding line, 20 indicates a pressure vessel, 21 indicates a vessel body, 22 indicates a lid, 23 indicates a partition plate, 24 indicates a concentrated water chamber, 25 indicates a treated water chamber, 26 indicates an insulating and sealing member, 27 indicates an insulating lining, 28a indicates a feeding port, 28b indicates a concentrated water outlet, 28c indicates a treated water outlet, 29 indicates a mounting bolt for the lid, and 30 indicates a terminal for connecting to DC (direct-current) power supply.

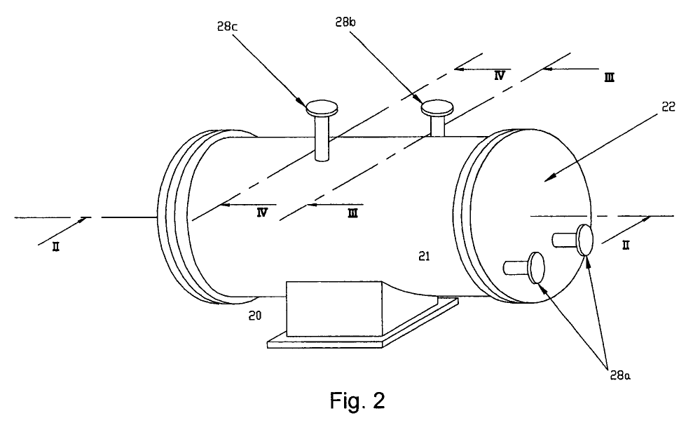

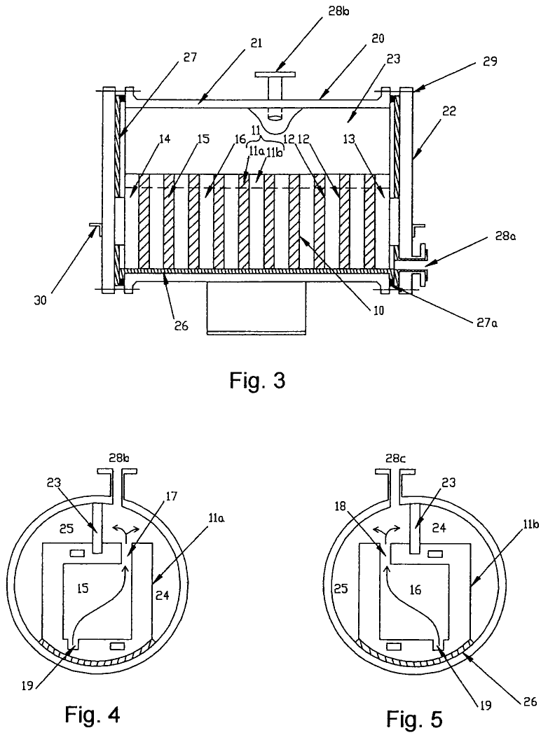

The high pressure-resistant type electrical deionization apparatus 1 shown in FIG. 2-5 comprises the electric deionization stack 10 housed in the pressure vessel 20.

The electric deionization stack 10 comprises a plurality of compartments partitioned by the compartment frame 11 and the ion exchange membrane 12. The compartments at opposite ends form the anode compartment 13 and the cathode compartment 14. The compartments, which are located between the anode compartment 13 and the cathode compartment 14, form at least one concentrating compartment 15 and at least one deionizing compartment 16. Each compartment frame 11a forming the concentrating compartment 15 has the concentrated water outlet 17. Each compartment frame 11b forming the deionizing compartment 16 has the treated water outlet 18. Each compartment is preferably filled with ion exchange non-woven fabrics. The pressure vessel 20 comprises the concentrated water chamber 24 and the treated water chamber 25 partitioned by the partition plate 23. Into the concentrated water chamber 24, the concentrated water flows from each concentrated water outlet 17 of the electric deionization stack 10. Into the treated water chamber 25, the treated water flows from each treated water outlet 18 of the electric deionization stack 10.

The pressure vessel 20 comprises a cylindrical vessel body 21 and a pair of lids 22 covering the opposite ends of the body 21. The lids 22 form a cathode and an anode of the electric deionization stack 10.

The electric deionization stack 10 is mounted on the insulating and sealing member 26 in the bottom of the pressure vessel 20. The insulating and sealing member 26 is preferably a non-conducting substance having adequate flexibility; for example, Teflon™ (registered trade mark of Du Pont). At the upper portion of the electric deionization stack 10, a groove for fitting the partition plate 23 welded to the upper inner surface of the pressure vessel 20 is provided. This helps alignment of each of compartments forming the electric deionization stack 10 and prevents the fluid from flowing between the concentrated water chamber 24 and the treated water chamber 25.

The lids 22 at the opposite ends of the pressure vessel 20 are made of a conductive metal. To the lids 22, a terminal for connecting to DC (direct-current) power supply 30 is attached. Application of DC to the lids 22 makes the lids the cathode and the anode. Thus, to protect against a short circuit inside the pressure vessel 20, the insulating lining 27 such as Teflon™ is applied to the lids 22 except for the portion contacting to the electric deionization stack 10. Around the insulating lining 27, the gasket 27a is positioned. In the present embodiment, the mounting bolt 29 for mounting the lid 22 on the vessel body 21 is an insulated bolt to prevent short circuit from the lid 22 to the vessel body 21.

In the present embodiment, the lid 22 is a flat plate. When the lid is constructed as a mirror structure wherein the flat plate contacting to the electric deionization stack 10 is attached to the inside of the lid, the pressure resistance is improved to allow the lid to be of reduced thickness.

The stack 10 is fastened to the lids 22 with a bolt. Thus, the entire length of the stack 10 prior to fastening is longer than the length between the lids 22 at the opposite ends to allow a margin to compensate for collapsing of packing of the stack 10 by the compression.

The pressure vessel 20 comprises, below one of the lids 22, a feeding port 28a for feeding the raw water and the concentrated water to the electric deionization stack 10. The feeding port 28a has an insulating lining 27 such as Teflon over the flange to maintain the electrical insulation. The flange of the piping is fastening by an insulated bolt. A concentrated water outlet 28b for discharging the concentrated water from the concentrated water chamber 24 and a treated water outlet 28c for discharging the treated water from the treated water chamber 25 are provided to the upper portion of the vessel body 21, respectively.

At the lower portion of the electric deionization stack 10, a liquid feeding line 19 for delivering the raw water and the concentrated water from the feeding port 28a to each compartment is provided by grooves formed in the lower portion of each compartment frame.

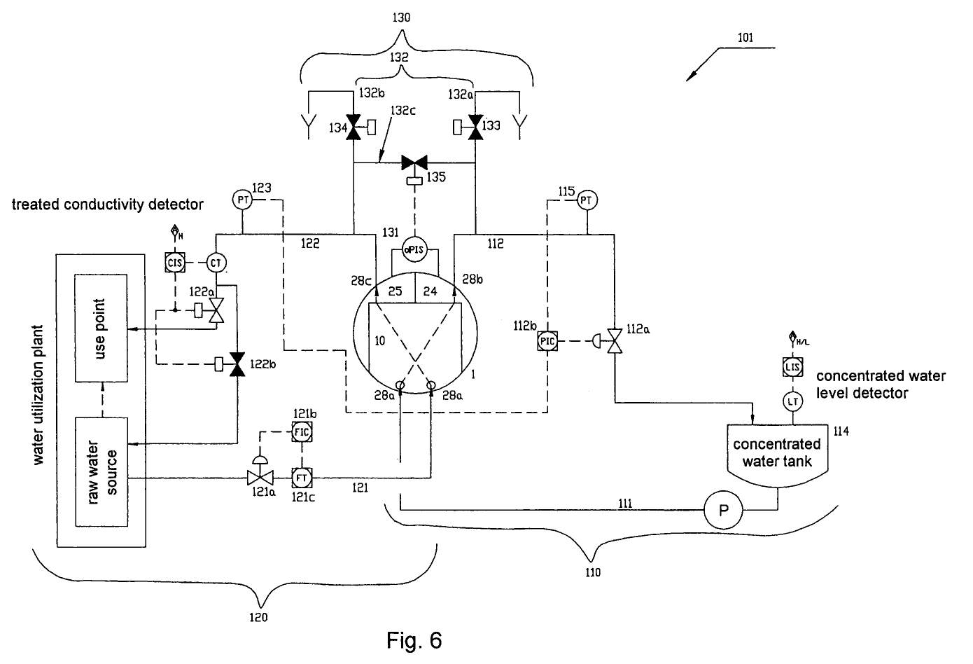

Next, a method of treating the raw water using the high pressure-resistant type electrical deionization apparatus in accordance with one embodiment of the present invention will be explained by referring to FIG. 6.

FIG. 6 is a schematic view of the high pressure-resistant type electrical deionization system with the high pressure-resistant type electrical deionization apparatus of the present invention.

The high pressure-resistant type electrical deionization system 101 shown in FIG. 6 comprises an electrical deionization apparatus 1; a concentrated water circulating system 110 for delivering the concentrated water to the electrical deionization apparatus 1 and storing the concentrated water from the electrical deionization apparatus 1 and then delivering the concentrated water to the electrical deionization apparatus 1; and an ultra pure water utilization system 120 for delivering the raw water to the electrical deionization apparatus 1 and recovering the treated water from the electrical deionization apparatus 1.

The concentrated water circulating system 110 comprises a concentrated water introduction line 111 connected to a feeding port 28a of the electrical deionization apparatus 1; a concentrated water discharge line 112 connected to a concentrated water outlet 28b of the electrical deionization apparatus 1; and a concentrated water tank 114. The concentrated water discharge line 112 comprises a concentrated water outlet pressure sensor 115 and a concentrated water outlet valve 112a. The concentrated water outlet pressure sensor 115 is electrically connected to the pressure controller for controlling the valve 112b.

The ultra pure water utilization system 120 comprises a raw water introduction line 121 and a treated water discharge line 122. The raw water introduction line 121 is connected to the feeding port 28a of the electrical deionization apparatus 1 and the raw water source of the water utilization plant. The treated water discharge line 122 is connected to the treated water outlet 28c and the use point of the water utilization plant. The raw water introduction line 121 comprises a raw water flow rate control valve 121a, a raw water flow rate controller 121b for controlling the valve 121a and a flow rate transmitter 121c. The treated water discharge line 122 comprises a treated water outlet pressure sensor 123, a valve 122a and a return valve 122b for the treated water. The treated water outlet pressure sensor 123 is electrically connected to the concentrated water outlet pressure controller 112b.

Ultra pure water is produced using the high pressure-resistant type electrical deionization system 101 of the present invention. When the electric deionization stack 10 is empty upon starting up of the system 101, each of the vent valves 133 and 134 is opened to start to deliver the raw water and the concentrated water to the electric deionization stack 10 to fill up the stack 10. Then, the vent valves 133 and 134 are closed. Next, the concentrated water and the raw water are fed in order into the stack 10, where they are deionized.

Concretely, the raw water is fed into the feeding port 28a for the raw water of the electrical deionization apparatus 1 via the raw water introduction line 121 from the source of the raw water of the use point. At the same time, the concentrated water is fed into the feeding port 28a for the concentrated water of the high pressure-resistant type electrical deionization apparatus 1 from the concentrated water tank 114 via the concentrated water introduction line 111. The electrical voltage is applied on the anode and the cathode of the high pressure-resistant type electrical deionization apparatus 1 to deionize the raw water. The deionized treated water is delivered to the use point of the water utilization plant through the treated water outlet 28c, via the treated water chamber 25 of the high pressure-resistant type electrical deionization apparatus 1 and through the treated water discharge line 122. On the other hand, the concentrated water is further concentrated in the high pressure-resistant type electrical deionization apparatus 10, and returned to the concentrated water tank 114 via the concentrated water chamber 24, through the concentrated water outlet 28b and the concentrated water discharge line 112. During the deionization, the flow rate of the raw water is controlled by the raw water flow rate control valve 121a to the amount of the water to be used in the use point. The treated water outlet pressure sensor 123 detects the pressure at the treated water outlet [A] flowing out from the high pressure-resistant type electrical deionization apparatus 1. The concentrated water outlet pressure sensor 115 detects the pressure at the concentrated water outlet [B] flowing out from the high pressure-resistant type electrical deionization apparatus 10. The signals of the pressure detected at the treated water outlet [A] and at the concentrated water outlet [B] are transported to the concentrated water outlet pressure controller 112b. The concentrated water outlet pressure controller 112b controls the concentrated water outlet pressure controller 112a such that the differential pressure between [A] and [B] are within ±0.05 MPa.

Also, the high pressure-resistant type electrical deionization system 101 of the present embodiment comprises a differential pressure control system 130 for buffering the sudden occurrence of the differential pressure between the concentrating compartment 15 (or the concentrated water chamber 24) and the deionizing compartment 16 (or the treated water chamber 25) of the high pressure-resistant type electrical deionization apparatus 1. The differential pressure control system 130 comprises differential pressure gauges 131 respectively connected to the concentrated water chamber 24 and the treated water chamber 25, piping for adjustment 132 connected to both the concentrated water side and the treated water side, a vent valve 133 provided on the concentrated water side, a vent valve 134 provided on the treated water side and a pressure equalizing valve 135.

The piping for adjustment 132 comprises a piping for the concentrated water 132a connected to the concentrated water discharge line 112, a piping for the treated water 132b connected to the treated water discharge line 122 and a piping for connection 132c for connecting them. A concentrated water vent valve 133 is mounted on the piping for the concentrated water 132a. The treated water vent valve 134 is mounted on the piping for the treated water 132b. The pressure-equalizing valve 135 is mounted on the piping for connection 132c. The pressure-equalizing valve 135 is connected to the differential pressure gauge 131 and is controlled on the basis of the electrical signal detected by the differential pressure gauge 131.

During the controlling process, the differential pressure gauge 131 monitors the differential pressure between the pressure of the treated water chamber 25 and the pressure of the concentrated water chamber 24. When the differential pressure exceeds the limit value, the pressure-equalizing valve 135 on the connection piping 132c is opened to overcome the differential pressure. In this case, the valve 122a and the valve 122d may be switched to return the treated water to the source of the raw water of the water utilization plant.

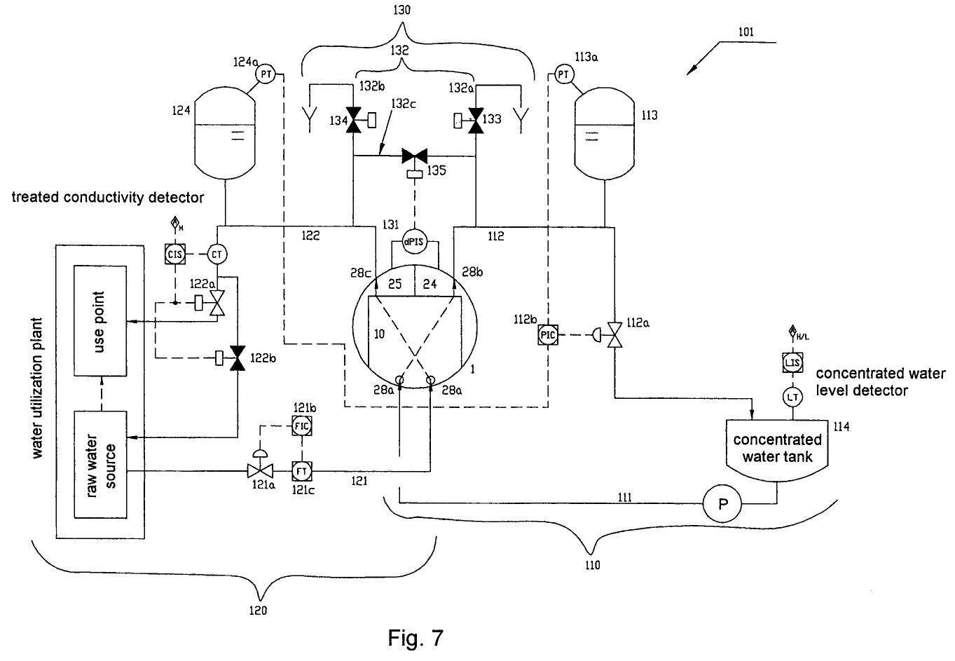

In the embodiment shown in FIG. 7, to avoid a sharp variation in pressure and to ease the pressure control, the concentrated water discharge line 112 and the treated water discharge line 122 comprise pressure accumulators 113 and 124, respectively. In FIG. 7, the same reference numbers indicate the same elements shown in FIG. 6, and explanation thereof is omitted.

The concentrated water discharge line 112 comprises the pressure accumulator 113 at the concentrated water outlet for suppressing the dramatic pressure change of the flow line of the concentrated water to ease the pressure control. The pressure accumulator 113 comprises a pressure transmitter 113a. The concentrated water discharge line 112 comprises a concentrated water outlet pressure controller 112a. The concentrated water outlet pressure controller 112a is connected to the concentrated water outlet pressure controller 112b.

The treated water discharge line 122 comprises a pressure accumulator 124 at the treated water outlet for suppressing a sharp variation in pressure change in the flow line of the treated water to ease the pressure control. The pressure accumulator 124 comprises a pressure transmitter 123a. The pressure transmitter 113a, the concentrated water outlet pressure controller 112b, the pressure transmitter 124 are electrically connected to each other to control each of valves and pressure accumulators on the basis of the detected pressure.

System 101 of the present embodiment is operated as follows:

When system 101 is started up, in the case that the electric deionization stack 10 is empty, each of the vent valves 133 and 134 is opened to start to deliver the raw water and the concentrated water to the electric deionization stack 10 to fill up the stack 10. Then, the vent valves 133 and 134 are closed.

Next, the concentrated water and the raw water are fed into the stack 10 where they are deionized.

The treated water and the concentrated water are controlled by the concentrated water outlet pressure controller 112b such that the pressures within the pressure accumulator 113 and the pressure accumulator 124 are kept at the predetermined set values, respectively.

The concentrated water outlet pressure controller 112b performs a cascade control following the pressure within the pressure accumulator 124. The predetermined set value of the pressure of the pressure accumulator 113 varies depending upon the varying pressure of the pressure accumulator 124. The concentrated water outlet pressure controller 112b emits the output signal of the operating amount of the control valve necessary to allow the actual pressure of the pressure accumulator 113 to follow the set value. The pressure of the pressure accumulator 113 is controlled to equal the first set value of the pressure at the treated water outlet. Thus, the differential pressure between the concentrated water chamber 24 and the treated water chamber 25 of the electrical deionization apparatus 1, namely, the differential pressure between the concentrating compartment 15 and the deionizing compartment 16 of the electric deionization stack 10, barely occurs. Thus, the inside leakage of the electric deionization stack 10 is eliminated to allow adequate treatment of the raw water.

In the pressure control by the high pressure-resistant type electrical deionization apparatus of the present invention, the deionizing compartment 16 in the electric deionization stack 10 and the treated water chamber 24 in the pressure vessel 20, and the concentrating compartment 15 in the electric deionization stack 10 and the concentrated water chamber 25 in the pressure vessel 20 are respectively communicated with the fluid so that the differential pressure into and out of the electrical deionization stack 10 in the pressure vessel 20 can be ignored. In the present invention, the differential pressure to be controlled is preferably kept below 0.05 MPa to prevent internal leakage in the stack 10.

According to the high pressure-resistant type electrical deionization system using the high pressure-resistant type electrical deionization apparatus of the present invention, the raw water from the ultra pure water production process using the middle-high pressure wherein the prior electrical deionization apparatus is hard to apply due to the poor pressure resistance of the electric deionization stack, can be directly introduced into the electrical deionization apparatus without adjustment of the pressure using the reservoir tank and the pump, and the treated water maintaining the pressure is delivered to the ultra pure water production process. Thus, the waste liquid from the regeneration of ion exchange resin and waste materials such as the used ion exchange resin can be significantly reduced and the cost of chemicals for regeneration and new ion exchange resin can be reduced, whereby the total running cost can be reduced.

Also, in particular, the above effects are improved when the lids at opposite ends of the pressure vessel construct the anode and the cathode of the electric deionization stack and the stack is directly fasten by the lids, as well as an adequate sealing being applied on the bottom of the stack and inside the pressure vessel.

Incidentally, the piping of the present invention is not limited to the above embodiments and can be changed and modified without departing from the spirit of the present invention recited in the claims.

Although only exemplary embodiments of this invention have been described in detail above, the skilled artisan will readily appreciate that many modifications are possible in the exemplary embodiments without materially departing from the novel teaching and advantages of this invention. Accordingly, all such modifications are intended to be included within the scope of this invention.

The present application claims priority under U.S.C. section 119 to Japanese Patent Application No. 2007-265103, filed on Oct. 11, 2007. The entire disclosure of the Japanese patent application including specification, claims, drawings, and summary is incorporated herein by reference in its entirety.

What is claimed is:

1. A high pressure-resistant type electrical deionization apparatus comprising:
an electrical deionization stack comprising a plurality of compartments defined by frames and ion-exchange membranes wherein compartments positioned at opposite ends of the electrical deionization stack form an anode compartment and a cathode compartment, at least two compartments located between the cathode and anode compartments form at least one concentration compartment and at least one deionization compartment, a frame of the concentration compartment comprises a concentrated water inlet and a concentrated water outlet, the frame of the deionization compartment comprises a treated water inlet and a treated water outlet; and
a pressure-resistant vessel housing the electrical deionization stack and comprising a concentrated water chamber for receiving concentrated water from the concentrated water outlet of the electrical deionization stack and a treated water chamber for receiving treated water from the treated water outlet of the electrical deionization stack wherein the concentrated water chamber and the treated water chamber are defined by a partition plate.

2. A high pressure-resistant type electrical deionization apparatus in accordance with claim 1 wherein the pressure-resistant vessel comprises a cylindrical vessel body and a pair of lids positioned so as to cover the opposite ends of the cylindrical vessel body and wherein each of the pair of lids forms the cathode compartment and the anode compartment.

3. A high pressure-resistant type electrical deionization system comprising:
(A) a high pressure-resistant type electrical deionization apparatus comprising:
an electrical deionization stack comprising a plurality of compartments defined by frames and ion-exchange membranes wherein the compartments positioned at opposite ends of the electrical deionization stack form a cathode compartment and an anode compartment, at least two compartments positioned between the cathode and anode compartments form at least one concentration compartment and at least one deionization compartment, the frame of the concentration compartment comprises a concentrated water inlet and a concentrated water outlet, the frame of the deionization compartment comprises a treated water inlet and a treated water outlet; and
a pressure-resistant vessel housing the electrical deionization stack and comprising a concentrated water chamber for receiving concentrated water from the concentrated water outlet of the electrical deionization stack and a treated water chamber for receiving treated water from the treated water outlet of the electrical deionization stack wherein the concentrated water chamber and the treated water chamber are defined by a partition plate;
(B) a concentrated water introduction line and a concentrated water discharge line, each connected to the high pressure-resistant type electrical deionization apparatus;
a concentrated water tank connected to both the concentrated water introduction line and the concentrated water discharge line;
a concentrated water pressure detector for detecting a pressure of the concentrated water at the concentrated water outlet and a concentrated water control valve for controlling the pressure of the concentrated water at the concentrated water outlet, both provided on the concentrated water discharge line; and
a concentrated water pressure controller for controlling the concentrated water control valve; and
(C) a raw water introduction line and a treated water discharge line, both connected to the high pressure-resistant type electrical deionization apparatus;
a raw water flow control valve for controlling the flow rate of raw water provided on the water introduction line; and
a treated water pressure detector for detecting the pressure of the treated water at the treated water outlet provided on the treated water discharge line;
wherein the treated water pressure detector, the concentrated water pressure detector and the concentrated water control valve are electrically connected, and the concentrated water pressure control valve is controlled by the concentrated water pressure controller so that the pressure difference between the pressure of the treated water at the treated water outlet which is detected by the treated water pressure detector and the pressure of the concentrated water at the concentrated water outlet which is detected by the concentrated water pressure detector is ±0.05 MPa.

4. A high pressure-resistant type electrical deionization system in accordance with claim 3 further comprising a treated water pressure accumulator provided on the treated water discharge line and connected to the treated water pressure detector to detect the pressure within the treated water pressure accumulator; and wherein the concentrated water pressure controller controls the concentrated water pressure control valve in accordance with the pressure of the treated water detected by the treated water pressure detector.

5. A high pressure-resistant type electrical deionization system in accordance with claim 3 further comprising a concentrated water pressure accumulator provided on the concentrated water discharge line and connected to the concentrated water pressure detector to detect the pressure within the concentrated water pressure accumulator.

6. A high pressure-resistant type electrical deionization system in accordance with claim 4 further comprising a concentrated water pressure accumulator provided on the concentrated water discharge line and connected to the concentrated water pressure detector to detect the pressure within the concentrated water pressure accumulator.

7. A high pressure-resistant type electrical deionization system in accordance with claim 3 further comprising:
a differential pressure detector for detecting the differential pressure between the pressures within the concentrated water chamber and the treated water chamber; and
an equalizing valve which is controlled in accordance with the differential pressure detected by the differential pressure detector and is connected to both the treated water discharge line and the concentrated water discharge line.

8. A high pressure-resistant type electrical deionization system in accordance with claim 4, further comprising:
a differential pressure detector for detecting the differential pressure between the pressures within the concentrated water chamber and the treated water chamber; and
an equalizing valve which is controlled in accordance with the differential pressure detected by the differential pressure detector and is connected to both the treated water discharge line and the concentrated water discharge line.

9. A high pressure-resistant type electrical deionization system in accordance with claim 5 further comprising:
a differential pressure detector for detecting the differential pressure between the pressures within the concentrated water chamber and the treated water chamber; and
an equalizing valve which is controlled in accordance with the differential pressure detected by the differential pressure detector and is connected to both the treated water discharge line and the concentrated water discharge line.

10. A high pressure-resistant type electrical deionization system in accordance with claim 3 for treating service water for an atomic power plant and discharging water from an atomic power plant.

11. A method of producing ultrapure water using the high pressure-resistant type deionization system comprising:
(A) a high pressure-resistant type electrical deionization apparatus comprising:
an electrical deionization stack comprising a plurality of compartments defined by frames and ion-exchange membranes wherein the compartments positioned at the opposite ends of the electrical deionization stack form a cathode compartment and an anode compartment, at least two compartments positioned between the cathode and anode compartments form at least one concentration compartment and at least one deionization compartment, the frame of the concentration compartment comprises a concentrated water inlet and a concentrated water outlet, and the frame of the deionization compartment comprises a treated water inlet and a treated water outlet; and
a pressure-resistant vessel housing the electrical deionization stack and comprising a concentrated water chamber for receiving concentrated water from the concentrated water outlet of the electrical deionization stack and a treated water chamber for receiving treated water from the treated water outlet of the electrical deionization stack wherein the concentrated water chamber and the treated water chamber are defined by a partition plate;
(B) a concentrated water introduction line and a concentrated water discharge line, each connected to the high pressure-resistant type electrical deionization apparatus;
a concentrated water tank connected to both the concentrated water introduction line and the concentrated water discharge line;
a concentrated water pressure detector for detecting a pressure of the concentrated water at the concentrated water outlet and a concentrated water control valve for controlling the pressure of the concentrated water at the concentrated water outlet, both provided on the concentrated water discharge line; and
a concentrated water pressure controller for controlling the concentrated water control valve; and
(C) a raw water introduction line and a treated water discharge line, each connected to the high pressure-resistant type electrical deionization apparatus;
a raw water flow control valve for controlling the flow rate of raw water provided on the water introduction line; and
a treated water pressure detector for detecting the pressure of the treated water at the treated water outlet provided on the treated water discharge line;
wherein the treated water pressure detector, the concentrated water pressure detector and the concentrated water control valve are electrically connected, and the concentrated water pressure control valve is controlled by the concentrated water pressure controller so that the differential pressure between the pressure of the treated water at the treated water outlet which is detected by the treated water pressure detector and the pressure of the concentrated water at the concentrated water outlet which is detected by the concentrated water pressure detector is ±0.05 MPa,
the method comprising, during the deionization operation of the raw water by controlling the raw water flow rate control valve, setting the flow rate of the raw water to an amount required at a use point, introducing the raw water to the deionization compartment and the concentrated water to the concentration compartment and applying voltage on the cathode and the anode, the steps of:
detecting a pressure of the treated water at the treated water outlet [A] by the treated water pressure detector;
detecting a pressure of the concentrated water at the concentrated water outlet [B] by the concentrated pressure detector; and
controlling the concentrated water pressure at the concentrated water outlet using the concentrated water pressure control valve such that the differential pressure between the pressures [A] and [B] falls within ±0.05 MPa.

12. The method in accordance with claim 11 wherein the system further comprises a differential pressure detector for detecting the differential pressure between the pressures within the concentrated water chamber and the treated water chamber; and an equalizing valve which is controlled in accordance with the differential pressure detected by the differential pressure detector,
wherein the equalizing valve is opened to stop the operation of the system when the differential pressure between the treated water pressure [A] and the concentrated water pressure [B] exceeds a final set value determined by strength of the ion-exchange membranes of the electrical deionization stack.

13. The method in accordance with claim 12 wherein the final set value determined by strength of the ion-exchange membranes is ±0.4 MPa.
